(19) United States
(12) Patent Application Publication
(10) Pub. No.: US 2025/0348765 A1
(43) Pub. Date: Nov. 13, 2025

(54) RETRIEVAL AUGMENTED GENERATION IN ARTIFICIAL INTELLIGENCE MODELS

(71) Applicant: QUALCOMM Incorporated, San Diego, CA (US)

(72) Inventors: Anantharaman BALASUBRAMANIAN, San Diego, CA (US); Arvind Vardarajan SANTHANAM, San Diego, CA (US)

(21) Appl. No.: 18/662,598

(22) Filed: May 13, 2024

(51) Int. Cl. G06N 5/04

(52) U.S. Cl. CPC G06N 5/04

(57) ABSTRACT

Certain aspects of the present disclosure provide techniques and apparatus for improved machine learning. In an example method, an input prompt for machine learning is received, and the input prompt is decomposed to generate a set of sub-prompts. A sequence of requests for sub-prompts of the set of sub-prompts that have sequential dependency is generated, and a parallel request for sub-prompts of the set of sub-prompts that do not have sequential dependency is generated. Based on evaluating the sequence of requests and the parallel request, an execution plan for using one or more machine learning models to generate a response to the input prompt is generated. The response to the input prompt is output according to the execution plan.

### INTRODUCTION

Aspects of the present disclosure relate to machine learning.

A wide variety of machine learning model architectures have been trained to perform an assortment of diverse tasks, including computer vision tasks, language tasks, classification and regression tasks, and the like. Recently, natural language processing (NLP) research has yielded substantial success in using large language models (LLMs) to process and generate natural language text. One area of interest is on-device enablement of retrieval augmented generation (RAG) (e.g., on mobile devices). Generally, mobile devices (and other devices with relatively limited computational resources) can only store and use small models, substantially limiting the devices' ability to perform advanced tasks (e.g., to answer complex queries).

### BRIEF SUMMARY

Certain aspects of the present disclosure provide a processor-implemented method, comprising: receiving an input prompt for machine learning; decomposing the input prompt to generate a set of sub-prompts; generating a sequence of requests for sub-prompts of the set of sub-prompts that have sequential dependency; generating a parallel request for sub-prompts of the set of sub-prompts that do not have sequential dependency; based on evaluating the sequence of requests and the parallel request, generating an execution plan for using one or more machine learning models to generate a response to the input prompt; and outputting the response to the input prompt according to the execution plan.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain aspects of the present disclosure and are therefore not to be considered limiting of the scope of this disclosure.

FIG. 1 depicts an example workflow for retrieval augmented generation, according to some aspects of the present disclosure.

FIG. 2 depicts an example workflow to efficiently perform retrieval augmented generation, according to some aspects of the present disclosure.

FIG. 3 is a flow diagram depicting an example method for efficient retrieval augmented generation, according to some aspects of the present disclosure.

FIG. 4 is a flow diagram depicting an example method for evaluating prompt offload criteria, according to some aspects of the present disclosure.

FIG. 5 is a flow diagram depicting an example method for executing parallel and sequential queries, according to some aspects of the present disclosure.

FIG. 6 is a flow diagram depicting an example method for processing input prompts using machine learning, according to some aspects of the present disclosure.

FIG. 7 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for providing improved retrieval augmented generation.

In some aspects, retrieval augmented generation (RAG) can be used to enhance machine learning performance on a variety of computing devices (including limited devices such as mobile phones). RAG generally includes generating responses to input prompts (also referred to as queries in some aspects) based in part on retrieving relevant information from other sources (e.g., servers or cloud-based systems). For example, if the query asks how old the author of a specific book is, the system may retrieve the relevant information (e.g., the identity of the author of the book, as well as the age of that individual) before generating the actual natural language response (using a machine learning model, such as an LLM or other generative artificial intelligence (AI) model).

In many cases, the ability to retrieve relevant information is important to enable on-device LLMs to effectively answer queries. However, there may be substantial costs incurred (e.g., in terms of latency) if the device accesses the cloud for every query to retrieve relevant information. On the other hand, the complexity of the query may be such that the on-device models may not be capable of answering the query effectively, or may rely on multiple sequential retrievals (incurring high latency), making use of a larger model housed in the cloud more effective.

In aspects of the present disclosure, techniques are provided to enable hybrid artificial intelligence (AI) designs to optimize on-device RAG that enables a device to perform effective retrieval that minimizes (or at least reduces) latency while maximizing (or at least increasing) accuracy. Latency incurred by on-device RAG depends on several factors, including the time to retrieve appropriate or relevant content (tᵣ) (e.g., the time to access the edge or cloud to retrieve the data) and/or the time for the LLM to generate the answer to the input query, given that the appropriate content has been retrieved (tₗ) (e.g., determined based on the LLM model size, any cache optimizations, hardware limitations, and the like).

In some aspects, the device may first split the received query into a set of subqueries, and then process each sub-query to answer the input query. For example, suppose the input query is “Where was the author of The Grapes of Wrath born?” The device may decompose the query into a first subquery Q1 (e.g., “author of The Grapes of Wrath”), which may then be transmitted to the cloud to retrieve a content C1 (e.g., “John Steinbeck”). The device may then use the local machine learning model (e.g., LLM) to generate a first answer A1 for the first subquery (e.g., “the author of The Grapes of Wrath is John Steinbeck”). The device may then formulate a second subquery Q2 based in part on this first answer (e.g., “birthplace of John Steinbeck”), and access the cloud to retrieve content C2 in response to this second subquery (e.g., “Salinas, California”), and so on until each subquery has been processed and an answer to the input query can be generated.

That is, some subqueries are inherently sequential (e.g., the device must determine the author of the book before determining the birthplace of the author). However, in some cases, the device can leverage parallel subqueries for some requests. For example, suppose the input query is “Is San Diego more populated than Seattle?” Two subqueries (“population of San Diego” and “population of Seattle”) can be answered in parallel, as the response to each does not depend on the response to the other. In some aspects, therefore, the device can utilize a parallel request to retrieve answers to both subqueries in parallel, substantially reducing the latency incurred by the answer generation process. The device can then compare the two responses locally and generate an output natural language answer using the local LLM.

In some aspects of the present disclosure, the computing device can determine the number of times that the cloud will be accessed to perform retrieval for a given input query. Further, the device may also determine which portions (if any) of the retrieval will be performed sequentially, and which (if any) can be performed in parallel. Query bundling can be performed for those subqueries that can be performed in parallel. For example, multiple subqueries may be stacked and provided via a single application programming interface (API) call to obtain the relevant content in one shot. In some aspects, the estimated time for answering the query on device can be compared with an estimated time for cloud-based response in order to decide whether the query should be answered on-device, offloaded to the cloud, or executed using a combination of the two.

Specifically, in some aspects, the device machine learning model receives an input query (also referred to in some aspects as an input prompt) as input and decomposes the input query into a sequence of subqueries (also referred to in some aspects as sub-prompts), which may include zero or more subqueries having sequential dependency (e.g., modeled as a query graph) and zero or more subqueries that do not have such sequential dependency (e.g., that can be executed in parallel). Based on this sequence, the device may generate an execution plan, which may indicate whether to execute the query locally, remotely, or both locally and remotely, how many requests to send to the cloud, which subqueries to bundle, in what sequence to send the subqueries, and the like. This can substantially improve the answer generation process, such as by reducing latency and improving accuracy.

### Example Workflow for Retrieval Augmented Generation

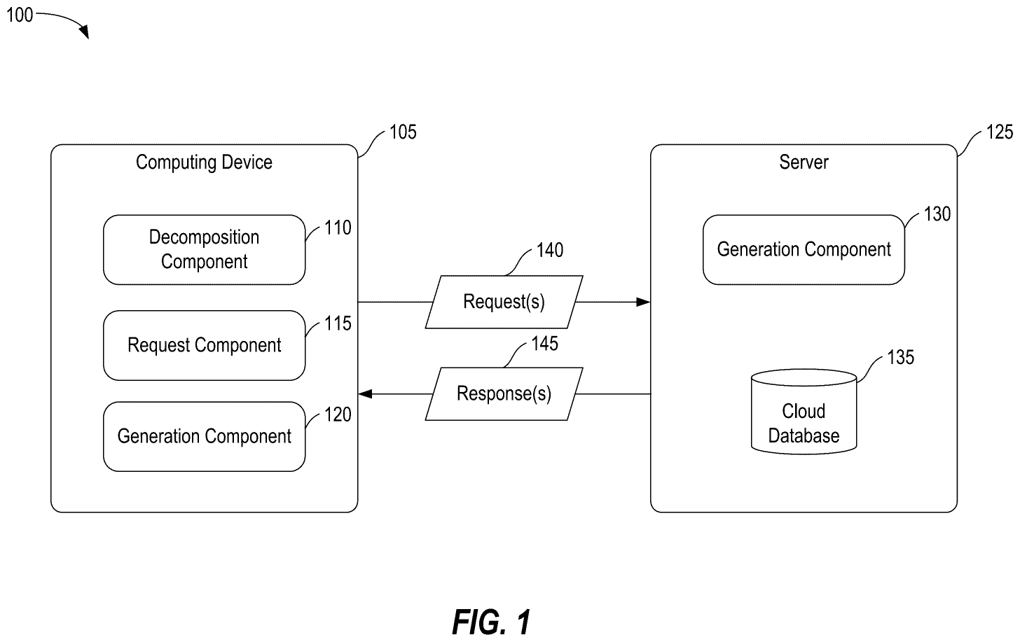

FIG. 1 depicts an example workflow 100 for retrieval augmented generation, according to some aspects of the present disclosure.

In the illustrated example, a computing device 105 is communicably coupled with a server 125. The computing device 105 may generally represent any system capable of performing the operations described herein. In some aspects, the computing device 105 corresponds to a device having relatively limited computational resources, as compared to the server 125. For example, the computing device 105 may comprise a smart phone or other mobile device, a tablet, a laptop computer, a wearable device, and the like. In some aspects, the computing device 105 is powered by battery, which may further limit the ability of the computing device 105 to perform complex operations.

In the illustrated example, the server 125 is generally representative of a computing system that is relatively more powerful or capable, as compared to the computing device 105. For example, the server 125 may represent hardware in a cloud deployment. Although depicted as a discrete system for conceptual clarity, in some aspects, the server 125 may represent any number of computing systems including any number of virtual and/or physical components. The computing device 105 and the server 125 may generally be communicably coupled using any suitable links, including wired links, wireless links, or a combination of wired and wireless links. In some aspects, the computing device 105 and the server 125 are linked via the Internet.

As illustrated, the computing device 105 includes a decomposition component 110, a request component 115, and a generation component 120. Although depicted as discrete components for conceptual clarity, in some aspects, the operations of the depicted components (and others not illustrated) may be combined or distributed across any number and variety of components.

In some aspects, the decomposition component 110 is used to decompose received input prompts (e.g., received from user(s)) to generate a set of sub-prompts (e.g., a sequence). For example, the decomposition component 110 may generate a query graph representing the ordering of the sub-prompts. In some aspects, as discussed above, some or all of the sub-prompts may have sequential dependency, and some or all of the sub-prompts may lack such sequential dependency. For example, the decomposition component 110 may generate a first set or sequence of sub-prompts that have sequential dependency, and a second set of sub-prompts that lack sequential dependency (and can be executed in parallel). In some aspects, as discussed above, the decomposition component 110 processes the prompt using one or more machine learning models (e.g., LLMs) to generate the sub-prompts and/or to identify the sequential dependencies (or lack thereof).

In some aspects, the request component 115 may evaluate the sub-prompts (e.g., the sequence of requests or sub-prompts that have sequential dependency, as well as the parallel request(s) containing sub-prompts without such sequential dependency) to generate an execution plan. As discussed above, this execution plan may generally include determining to generate the response locally, or determining to offload some or all of the sub-prompts to the server 125 for execution.

In some aspects, to generate the execution plan, the request component 115 may evaluate factors such as the number of sub-prompts (e.g., to determine whether the number of sub-prompts exceeds a defined threshold, which may be a hyperparameter). For example, in some aspects, the request component 115 may determine to offload the query if the number of sub-prompts is greater than one (e.g., using the local model to generate a response if the input query is extractive, and sending other more complex queries to the cloud).

As another example, the request component 115 may evaluate the number of retrievals from the server 125 (referred to in some aspects as cloud-based data retrievals) that will be used to answer the query on the local computing device 105. For example, if the number of cloud retrievals meets or exceeds a threshold (which may be a hyperparameter), the request component 115 may determine to offload the query, as it may be faster to send the query and receive a response rather than sending multiple retrieval requests and generating a response.

As another example, the request component 115 may determine or estimate the total time that will be incurred for answering the input prompt on the computing device 105, and determine whether this estimate meets or exceeds a threshold (which may be a hyperparameter) and/or whether the estimated time exceeds the estimated time that will be incurred to answer the input on the server 125. For example, suppose the number of sequential retrievals (e.g., the number of requests or sub-prompts having sequential dependency) is nₛ and the number of parallel retrievals (e.g., the number of bundled requests that each include multiple parallel sub-prompts) is nₚ. In some aspects, the time incurred for executing the sequential retrieval requests may be defined as nₛ(tᵣ+tₗ), while the time incurred for executing the parallel request(s) may be defined as (not)+tₗ).

More specifically, in some aspects, the problem of performing sequential and parallel retrievals by the computing device 105 may be formulated as an optimization problem according to Expression 1 below, where t_{rd} is the time incurred for the computing device 105 to retrieve relevant data (e.g., from the server 125), t_{ld} is the time incurred by the computing device 105 to generate an answer using a local machine learning model, nₛ and nₚ are the number of sequential and parallel requests, respectively, for the computing device 105, nₛ+nₚ≥1 (e.g., there is at least one sub-prompt), nₛ≥0, and nₚ≥0 (e.g., there are zero or more sequential sub-prompts and zero or more parallel sub-prompts):

$$\begin{matrix}min \\ ( {n}_{s} , {n}_{p} )\end{matrix} = {n}_{s} ( {t}_{rd} + {t}_{ld} ) + ( {n}_{p} {t}_{rd} + {t}_{ld} ) \qquad ( 1 )$$

Given a set of requests (which may include sequential and/or parallel requests), the request component 115 may therefore seek to sequence the requests to minimize Expression 1. This may enable the request component 115 to estimate the time to execute the query locally, while offloading retrieval requests.

In some aspects, a similar optimization problem may be formulated according to Expression 2 below to determine the sequencing, and hence cost, of executing the query on the server 125:

$$\begin{matrix}min \\ ( {n}_{s}^{c} , {n}_{p}^{c} )\end{matrix} = {n}_{s}^{c} ( {t}_{rc} + {t}_{lc} ) + ( {n}_{p}^{c} {t}_{rc} + {t}_{lc} ) \qquad ( 2 )$$

In Expression 2, t_{rc} is the time incurred for the server 125 to retrieve relevant data, t_{lc} is the time incurred by the server 125 to generate an answer using a local (e.g., cloud-based) machine learning model, and

$${n}_{s}^{c} and {n}_{p}^{c}$$

are the number of sequential and parallel requests, respectively, for the server 125.

Given a set of requests (which may include sequential and/or parallel requests), the request component 115 may therefore seek to sequence the requests to minimize Expression 2 to estimate the time to execute the query on the server 125. In some aspects, t_{rc} <t_{rd} as the server 125 is generally closer to the content that will be retrieved (e.g., via the cloud database 135), and [symbol] > [symbol] as the model(s) used by the server 125 are generally much larger than those used by the computing device 105.

In the illustrated example, based on the generated execution plan, the request component 115 can transmit one or more requests 140 to the server 125. The server 125 may use a generation component 130 to generate responses (which may include accessing content from the cloud database 135), and transmit responses 145 to the computing device 105. In some aspects, the generation component 130 generally uses one or more machine learning models (e.g., LLMs) to generate responses to the request(s) 140. The cloud database 135 is generally representative of one or more data repositories that can be accessed to retrieve data relevant to the request(s) 140.

In the depicted workflow 100, the generation component 120 of the computing device 105 can then optionally process one or more of the responses 145 and/or one or more of the sub-prompts generated by the decomposition component 110 to generate an output response to the input prompt. For example, as discussed above, the generation component 120 may process responses 145 (e.g., indicating the author of a book) to generate a new sub-prompt requesting detail about that author, and may combine the responses to generate a final output answering the input prompt. As another example, the generation component 120 may receive a final generated response from the server 125 (e.g., if the entire prompt is offloaded), and may output this response. The generation component 120 may then output the final response (e.g., via a display, speaker, or other output device). For example, the generation component 120 may output the response to the requesting entity (e.g., the user that provided the input prompt).

In some aspects, to generate the request(s) 140, the computing device 105 may use techniques such as named entity recognition (NER) to identify the relevant entities for which data is relevant, and may use these recognized entities as input to retrieve the relevant data. Although not depicted in the illustrated example, in some aspects, the computing device 105 may use NER to perform data prefetching and on-device caching to expedite answer generation. For example, in addition to requesting the indicated information for the named entity, the computing device 105 may request a knowledge graph (KG) associated with the named entity.

For example, if the request asks “where was the spouse of the current US president born,” the computing device 105 may request a KG relating to the current US president. In some aspects, the particular KG associated with a given named entity may be determined or preconfigured based on the type of the entity (e.g., KGs containing certain types of information for celebrities, certain types of information for politicians, certain types of information for geographic locations, and the like). For example, KGs for politicians and celebrities may include information relating to their family details, books authored, and the like.

Similarly, in some aspects, the computing device 105 may request one or more KGs related to the named entity. For example, if the identified named entity is “George Washington,” the computing device 105 may identify other related named entities (e.g., locally, or via a KG for the first named entity) and request additional KGs for related named entities (e.g., “Martha Washington”) to answer possible future questions. As another example, the computing device 105 may request specific portion(s) of the KG(s) based on the related named entities. For example, if the named entity is “George Washington” and other named entities (in the KG or in the prompt) include “Alexander Hamilton,” the computing device 105 may request portions of a KG for George Washington that are relevant to Alexander Hamilton (or vice versa).

By retrieving the KG(s) and caching the KG(s) locally, the computing device 105 may be able to answer subsequent prompts (or sub-prompts) much more rapidly. For example, the computing device 105 may avoid one or more sequential queries to the server 125 if some or all of these queries can be answered using the KG.

### Example Workflow to Efficiently Perform Retrieval Augmented Generation

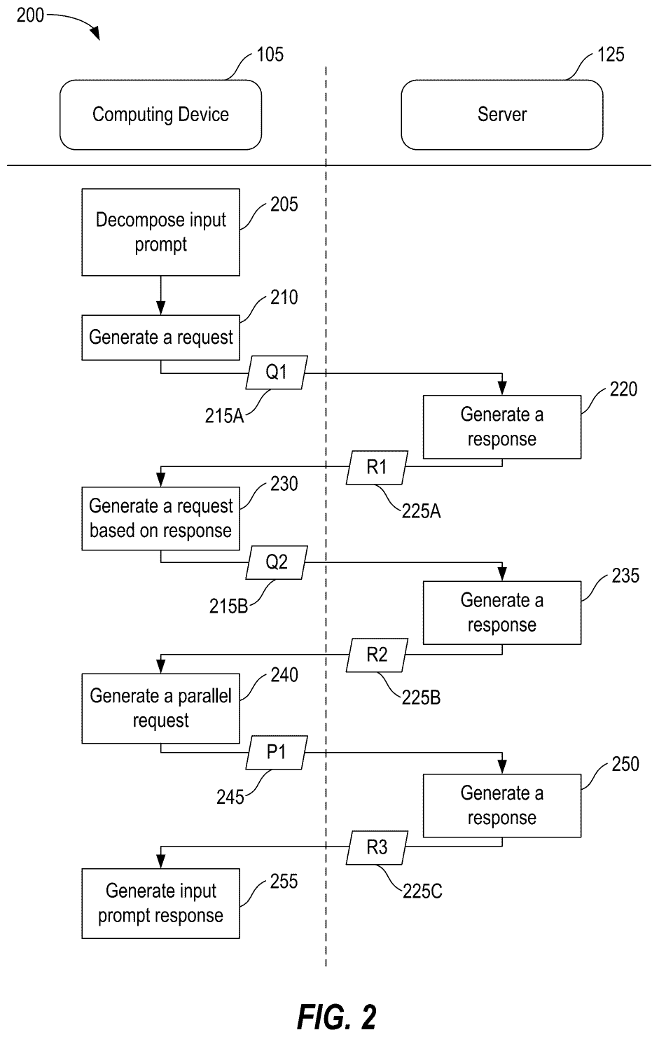

FIG. 2 depicts an example workflow 200 to efficiently perform retrieval augmented generation, according to some aspects of the present disclosure. Specifically, the illustrated workflow 200 depicts a process of retrieving data and generating output responses by a computing device 105 with the help of a server 125.

In the illustrated example, at block 205, the computing device 105 decomposes an input prompt (e.g., received from a user) into a set of sub-prompts (e.g., a set of sequential sub-prompts and/or a set of parallel sub-prompt(s)). In the illustrated example, it is assumed that the computing device 105 decomposed the prompt into two sub-prompts having sequential dependency, as well as one or more sub-prompts that do not have sequential dependency. Generally, the particular dependencies will vary depending on the particular prompt and implementation. Further, various sub-prompts may have more complex dependencies, such as if two sub-prompts have no sequential dependency with respect to each other, but one or both may have sequential dependency with respect to one or more other sub-prompts. Similarly, in some aspects, a sub-prompt having sequential dependency may be bundled with a sub-prompt that does not have such dependency, allowing the computing device 105 to retrieve information more efficiently.

At block 210, the computing device 105 generates a request for a first sub-prompt. As illustrated, this request 215A is depicted as a single request for a sub-prompt having sequential dependency. That is, the request 215A will return an answer that is relevant or used to generate a subsequent request. In the illustrated example, the server 125 receives the request 215A and generates a first response 225A (referred to in some aspects as a sub-response) at block 220 (e.g., using a local machine learning model and/or a repository of information). At block 230, the computing device 105 uses this response 225A to generate a further request 215B for another sub-prompt. At block 235, the server 125 generates a second response 225B for this second request 215B.

For example, the first request 215A may have been “who is the author of ‘To Kill a Mockingbird,’” the first response 225A may have been “Harper Lee,” the second request 215B may have been “when was Harper Lee born,” and the second response 225B may have been “1926.”

As illustrated, at block 240, the computing device 105 then generates a parallel request 245 which comprises one or more sub-prompts that do not have sequential dependency with respect to each other (though one or more may have sequential dependency with respect to other sub-prompts, such as those included in the request 215A and/or the request 215B). For example, the parallel request 245 may be a bundled request including multiple sub-prompts, such as “when was Truman Capote born” and “when was Audrey Hepburn born” (e.g., if the original input request was “who was born first: Audrey Hepburn, Truman Capote, or the author of To Kill a Mockingbird?”).

At block 250, the server 125 generates a response 225C for this parallel request 245 (e.g., indicating “1924” and “1929,” respectively). At block 255, the computing device 105 then generates a response to the input prompt based at least in part on the response 225C. For example, the computing device 105 may compare the responses, and use a machine learning model (e.g., an LLM) to generate a natural language response such as “Truman Capote was born first in 1924, followed by Harper Lee in 1926 and Audrey Hepburn in 1929.”

Although the illustrated example depicts first processing the sequential requests and then processing the parallel requests, as discussed above, the computing device 105 may generally execute the sub-prompts in any order, and may combine or distributed requests that lack sequential dependency in any way (e.g., depending on the sequential dependencies between sub-prompts, and in an effort to minimize the execution time). For example, if the sub-prompts included in the request 245 have no sequential dependency with any other sub-prompts, the computing device 105 may instead generate a parallel request at block 210 and/or at block 230 to include these sub-prompts, allowing the final answer to be generated more rapidly. That is, the request 215A may include “who is the author of To Kill a Mockingbird,” “when was Truman Capote born,” and “when was Audrey Hepburn born” in a single parallel request.

### Example Method for Efficient Retrieval Augmented Generation

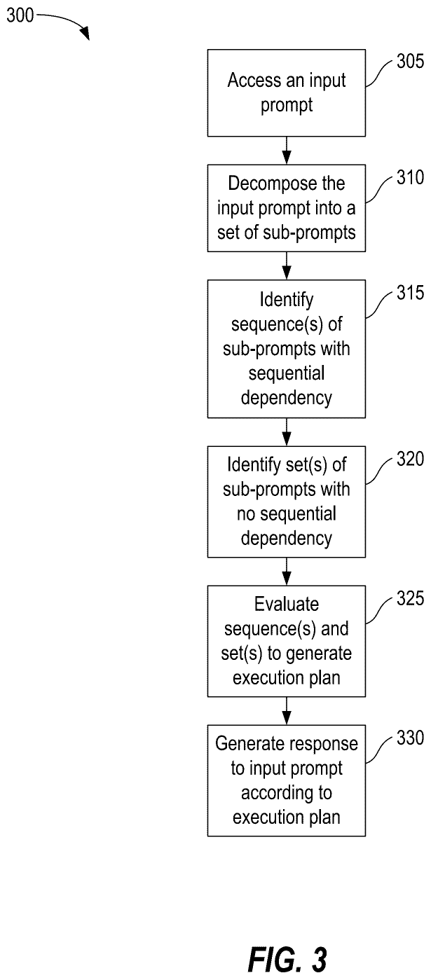

FIG. 3 is a flow diagram depicting an example method 300 for efficient retrieval augmented generation, according to some aspects of the present disclosure. In some aspects, the method 300 is performed by a computing device, such as the computing device 105 of FIGS. 1 and 2.

At block 305, the computing device accesses an input prompt. As used herein, “accessing” data may generally include receiving, requesting, retrieving, obtaining, generating, or otherwise gaining access to the data. For example, the input prompt may be received from a requesting entity, such as a user. In some aspects, the input prompt comprises natural language (e.g., text or audio) indicating a request or question to be answered by the computing device.

At block 310, the computing device decomposes the input prompt into a set of sub-prompts, as discussed above. For example, the computing device may process the input prompt using a machine learning model (e.g., an LLM) to generate a respective sub-prompt for each logical portion of the input prompt (e.g., based in part on named entity recognition). As discussed above, in some aspects, each sub-prompt generally corresponds to a question that should be answered (e.g., a question for which information or a response is relevant) in order to answer the input prompt.

At block 315, the computing device identifies zero or more sequences of sub-prompts that have sequential dependency (e.g., sub-prompts where the input of each sub-prompt, other than the first, is dependent on the output of at least one other sub-prompt). For example, as discussed above, the computing device may generate a query graph reflecting the dependencies. As discussed above, in some aspects, some or all of the sub-prompts having sequential dependencies with each other may lack such dependencies with one or more other sub-prompts, potentially enabling bundled parallel execution with other non-dependent sub-prompts.

At block 320, the computing device identifies zero or more sets of sub-prompts that have no sequential dependency with respect to each other. In some aspects, as discussed above, one or more of the sub-prompts that lack sequential dependency with respect to each other may have sequential dependency with respect to one or more other sub-prompts. For example, the sequence of requests may include a first request with one sub-prompt, a parallel request with two sub-prompts that incorporate the answer to the first request, and so on.

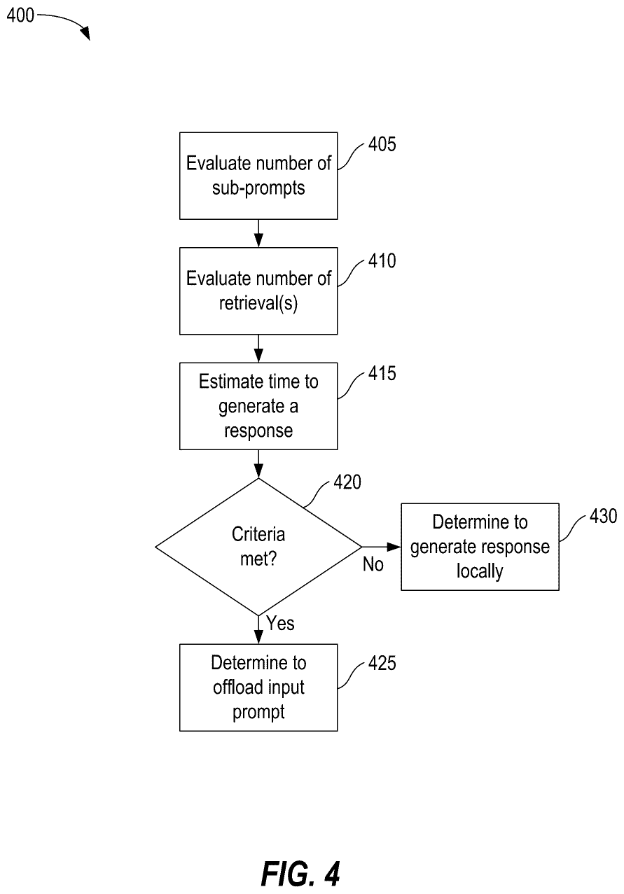

At block 325, the computing device evaluates the sequence(s) of sequential sub-prompts and the set(s) of non-sequential sub-prompts in order to generate an execution plan, as discussed above. For example, the computing device may seek to minimize Expression 1 to find an optimal (or at least improved) ordering and bundling of sub-prompts (based on the sequential dependencies) to minimize (or at least reduce) the latency of generating a response. In some aspects, as discussed above, the computing device may additionally or alternatively estimate the latency of generating a response using the server, such as by minimizing (or at least reducing) Expression 2, above. In some aspects, generating the execution plan is discussed in more detail below with reference to FIG. 4.

At block 330, the computing device generates a response to the input prompt based on the execution plan. For example, as discussed above, if the execution plan indicates to complete at least a portion of the prompt locally, the computing device may execute the determined sequence of actions (which may include one or more single and/or parallel requests to a server, and/or one or more iterations of processing data using a local model to generate output). As another example, if the execution plan indicates to offload the entire prompt to the remote system (e.g., because the latency of generating an answer is expected to be lower), generating the response may include transmitting the prompt to the remote system and receiving the final response (or receiving the information relevant to generate a final response locally). In some aspects, as discussed above, the response generally comprises natural language (e.g., text or audio) responding to the input prompt.

Although not depicted in the illustrated example, in some aspects, the computing device can then output the response (e.g., to the requesting entity), such as via a display, speaker, and the like.

### Example Method for Evaluating Prompt Offload Criteria

FIG. 4 is a flow diagram depicting an example method 400 for evaluating prompt offload criteria, according to some aspects of the present disclosure. In some aspects, the method 400 is performed by a computing device, such as the computing device 105 of FIGS. 1-2 and/or the computing device discussed above with reference to FIG. 3. In some aspects, the method 400 provides additional detail for block 325 of FIG. 3.

At block 405, the computing device evaluates the total number of sub-prompts generated based on the input prompt. For example, as discussed above, the computing device may determine (at block 420) whether the number of sub-prompts satisfies one or more criteria, such as whether the number is below a threshold.

At block 410, the computing device evaluates the number of data retrieval(s) that will be used to generate a response (e.g., the number of sub-prompts that rely on data retrieval from a remote system, such as the server 125 of FIGS. 1-2). For example, as discussed above, the computing device may determine (at block 420) whether the number of retrievals satisfies one or more criteria, such as whether the number is below a threshold.

At block 415, the computing device estimates a time that will be consumed to generate a response to the input prompt. For example, as discussed above, the computing device may estimate how much time will be consumed to generate the response locally (e.g., based on the number of data retrievals used, the latency of such data retrievals, the number of sub-prompts that will be processed using machine learning, and the latency of such processing). In some aspects, as discussed above, the computing device may similarly estimate how much time will be consumed to generate the response remotely, such as by a server (e.g., based on the server's model execution time, latency of transmitting and receiving a response, and the like).

At block 420, the computing device determines whether one or more criteria are satisfied. For example, as discussed above, the criteria may include a maximum number of sub-prompts (where values meeting or exceeding the threshold may cause the computing device to offload the prompt), a maximum number of data retrievals (where values meeting or exceeding the threshold may cause the computing device to offload the prompt), a maximum or preferred execution time (e.g., where a local execution time meeting or exceeding a threshold, and/or a local execution time that is larger than then estimated remote execution time may cause the computing device to offload the prompt), and the like.

If, at block 420, the computing device determines that the criteria to offload the prompt are met, the method 400 continues to block 425, where the computing device determines to offload the prompt to one or more remote system(s) (e.g., the server 125 of FIG. 1) for execution. That is, the execution plan may include transmitting the prompt to the remote system, and awaiting a generated response.

Returning to block 420, if the computing device determines that the offload criteria are not met, the computing device determines to generate the response (at least partially) locally. In some aspects, as discussed above, generating the response locally may include generating the entire response without requests to the remote system(s) (e.g., for an extractive query), generating the response based on pre-cached data (e.g., KG(s)) locally, and/or generating the response by performing some operations locally and offloading some operations to the remote system (e.g., data requests).

### Example Method for Executing Parallel and Sequential Queries

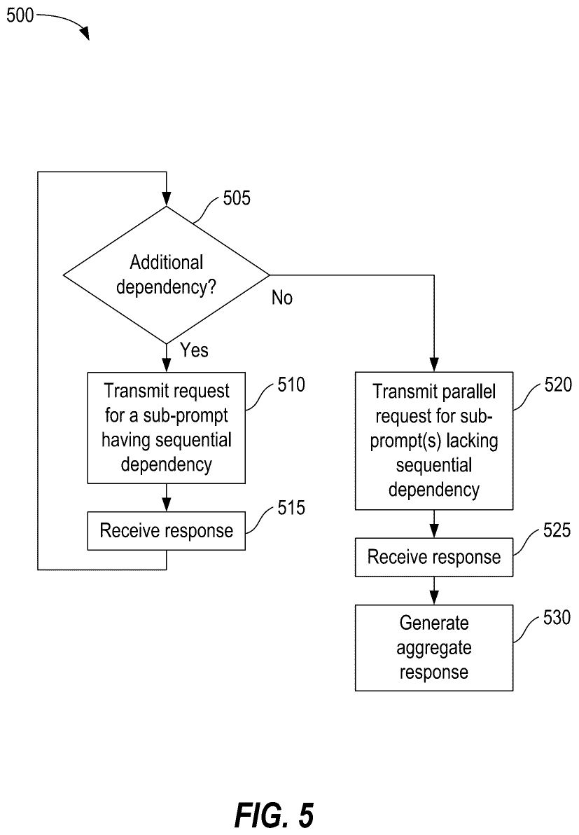

FIG. 5 is a flow diagram depicting an example method 500 for executing parallel and sequential queries, according to some aspects of the present disclosure. In some aspects, the method 500 is performed by a computing device, such as the computing device 105 of FIGS. 1-2 and/or the computing device discussed above with reference to FIGS. 3-4. In some aspects, the method 500 provides additional detail for block 330 of FIG. 3.

At block 505, the computing device determines whether there are any sequential dependencies in the sub-prompts for the input (e.g., whether the input for any of the sub-prompts relies on the response to another sub-prompt). If so, the method 500 continues to block 510, where the computing device transmits a request including the sub-prompt having sequential dependency (e.g., the sub-prompt that should be answered first).

At block 515, the computing device receives the response to this request, and the method 500 returns to block 505, where the computing device determines whether any further dependencies exist (e.g., whether there are other sub-prompts that cannot be executed until one or more other sub-prompts are complete). If so, the method 500 continues to block 510, and this loop iterates until each sequential dependency is resolved.

If, at block 505, the computing device determines that no further sequential dependencies exist, the method 500 continues to block 520. At block 520, the computing device transmits zero or more parallel requests including any sub-prompts that do not have sequential dependency (or for whom sequential dependencies have already been resolved).

At block 525, the computing device receives a response to this parallel or bundled request. At block 530, the computing device then generates an aggregated response based on the individual responses and sub-prompts, as discussed above.

Although the illustrated example depicts executing sequential requests first, and then executing parallel requests, it is to be understood that this ordering is merely for conceptual clarity and the computing device may execute the sub-prompts in any order. For example, the computing device may bundle the non-sequential sub-prompts into one or more of the sub-prompts transmitted at block 510, may transmit the parallel request first followed by sequential requests, may alternate between sequential and non-sequential requests, and the like (e.g., based on the query graph and/or to minimize execution time).

### Example Method for Processing Input Prompts Using Machine Learning

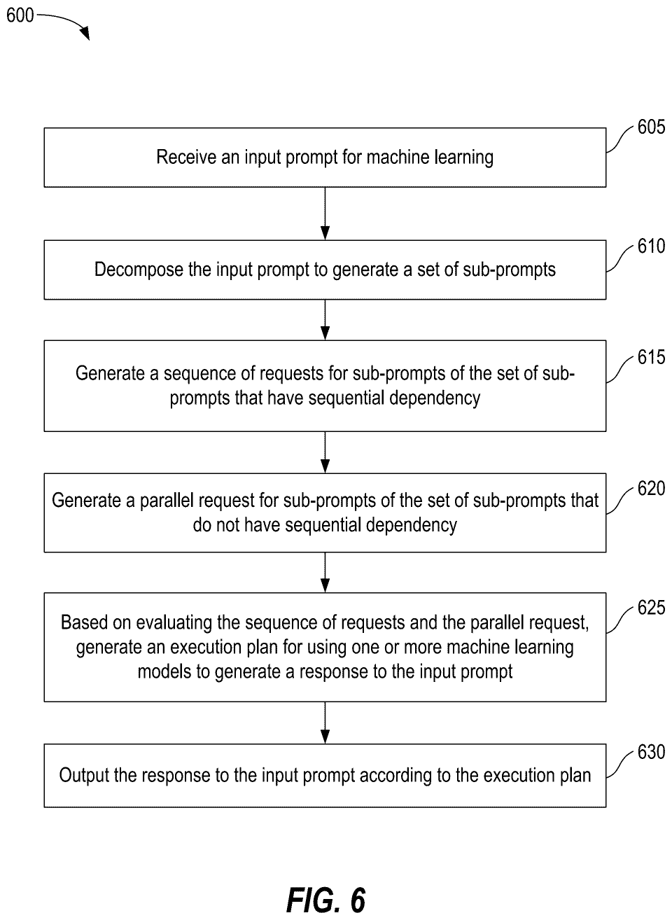

FIG. 6 is a flow diagram depicting an example method 600 for processing input prompts using machine learning, according to some aspects of the present disclosure. In some aspects, the method 600 is performed by a computing device, such as the computing device 105 of FIGS. 1-2 and/or the computing device discussed above with reference to FIGS. 3-5.

At block 605, an input prompt for machine learning is received.

At block 610, the input prompt is decomposed to generate a set of sub-prompts.

At block 615, a sequence of requests for sub-prompts of the set of sub-prompts that have sequential dependency is generated.

At block 620, a parallel request for sub-prompts of the set of sub-prompts that do not have sequential dependency is generated.

At block 625, based on evaluating the sequence of requests and the parallel request, an execution plan for using one or more machine learning models to generate a response to the input prompt is generated.

At block 630, the response to the input prompt is output according to the execution plan.

In some aspects, generating the execution plan comprises determining to offload the input prompt to one or more cloud-based machine learning models.

In some aspects, determining to offload the input prompt comprises determining that a number of the set of sub-prompts satisfies a threshold value.

In some aspects, determining to offload the input prompt comprises determining that a number of cloud-based data retrievals for the set of sub-prompts satisfies a threshold value.

In some aspects, determining to offload the input prompt comprises estimating a time to generate the response to the input prompt based on the sequence of requests and the parallel request and determining that the time satisfies a threshold value.

In some aspects, generating the execution plan comprises estimating a time to generate the response to the input prompt based on the sequence of requests and the parallel request, determining that the time fails to satisfy a threshold value, and locally generating the response to the input prompt according to the execution plan.

In some aspects, the method 600 further includes generating the response, including transmitting a first request of the sequence of requests to retrieve data for a first sub-prompt of the set of sub-prompts receiving a first sub-response for the first request, and transmitting a second request of the sequence of requests based on the first sub-response.

In some aspects, the method 600 further includes generating the response, including transmitting the parallel request to retrieve data for a plurality of sub-prompts of the set of sub-prompts receiving a sub-response for the parallel request generating the response based on the sub-response.

In some aspects, the method 600 further includes generating the response, including identifying a named entity in a first sub-prompt of the set of sub-prompts, and transmitting a request for data retrieval comprising the named entity and a request for a knowledge graph related to the named entity.

In some aspects, the method 600 further includes requesting a portion of the knowledge graph based on a set of related named entities based on the named entity.

In some aspects, the method 600 further includes receiving another input prompt for machine learning, and generating another response to the other input prompt using the knowledge graph.

### Example Processing System for Machine Learning

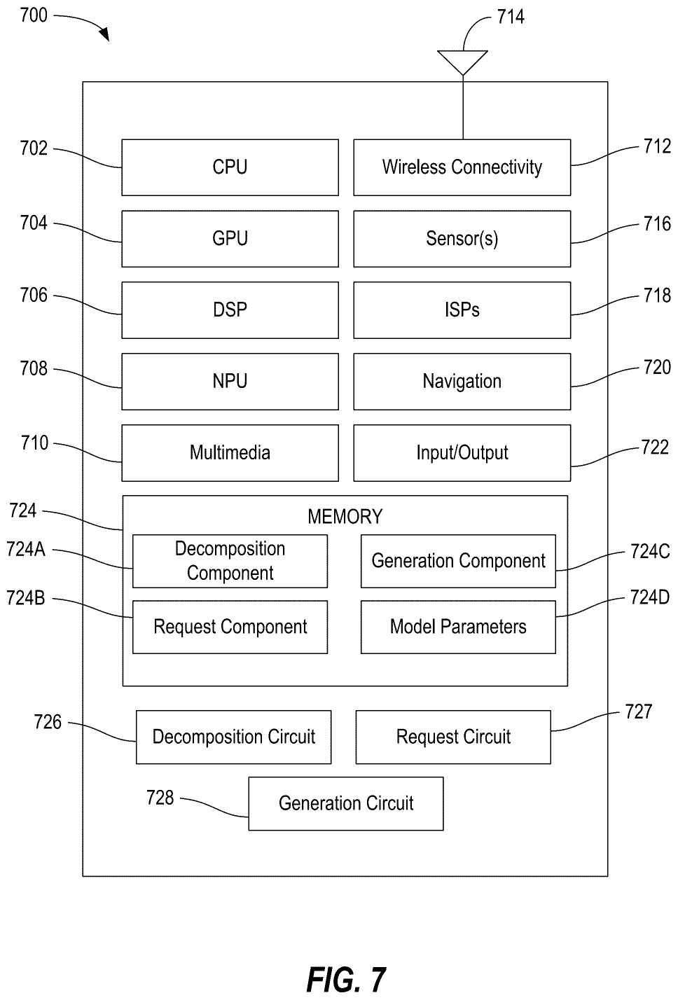

FIG. 7 depicts an example processing system 700 configured to perform various aspects of the present disclosure, including, for example, the techniques and methods described with respect to FIGS. 1-6. In some aspects, the processing system 700 may correspond to a computing device. For example, the processing system 700 may correspond to the computing device 105 of FIGS. 1-2, and/or the computing device discussed above with reference to FIGS. 3-6. Although depicted as a single system for conceptual clarity, in some aspects, as discussed above, the operations described below with respect to the processing system 700 may be distributed across any number of devices or systems.

The processing system 700 includes a central processing unit (CPU) 702, which in some examples may be a multi-core CPU. Instructions executed at the CPU 702 may be loaded, for example, from a program memory associated with the CPU 702 or may be loaded from a memory partition (e.g., a partition of a memory 724).

The processing system 700 also includes additional processing components tailored to specific functions, such as a graphics processing unit (GPU) 704, a digital signal processor (DSP) 706, a neural processing unit (NPU) 708, a multimedia component 710 (e.g., a multimedia processing unit), and a wireless connectivity component 712.

An NPU, such as the NPU 708, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 708 is a part of one or more of the CPU 702, the GPU 704, and/or the DSP 706.

In some examples, the wireless connectivity component 712 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The wireless connectivity component 712 is further coupled to one or more antennas 714.

The processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS) as well as inertial positioning system components.

The processing system 700 may also include one or more input and/or output devices 722, such as screens, touch-sensitive surfaces (including touch-sensitive displays), physical buttons, speakers, microphones, and the like.

In some examples, one or more of the processors of the processing system 700 may be based on an ARM or RISC-V instruction set.

The processing system 700 also includes a memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes a decomposition component 724A, a request component 724B, and a generation component 724C. Although not depicted in the illustrated example, the memory 724 may also include other components, such as an inferencing or generation component to manage the generation of output predictions using trained machine learning models, a training component used to train or update the machine learning model(s), and the like. Though depicted as discrete components for conceptual clarity in FIG. 7, the illustrated components (and others not depicted) may be collectively or individually implemented in various aspects.

As illustrated, the memory 724 also includes a set of model parameters 724D (e.g., parameters of one or more machine learning models, such as weights and/or biases, used to generate model output). For example, as discussed above, the model parameters 724D may include learned parameters for one or more LLMs or other models used to decompose queries, generate responses, and the like. Although not depicted in the illustrated example, the memory 724 may also include other data such as training data.

The processing system 700 further comprises a decomposition circuit 726, a request circuit 727, and a generation circuit 728. The depicted circuits, and others not depicted (such as an inferencing circuit), may be configured to perform various aspects of the techniques described herein.

The decomposition component 724A and/or the decomposition circuit 726 (which may correspond to the decomposition component 110 of FIG. 1) may be used to selectively decompose input prompts into a set of sub-prompts, as discussed above. For example, the decomposition component 724A and/or the decomposition circuit 726 may use machine learning or other techniques to identify the sub-prompts, and/or to determine the dependencies among the sub-prompts.

The request component 724B and/or the request circuit 727 (which may correspond to the request component 115 of FIG. 1) may be used to evaluate the sub-prompts and/or sequential dependencies to generate execution plans, as discussed above. For example, the request component 724B and/or the request circuit 727 may evaluate the sub-prompts and/or estimated latency using one or more criteria (e.g., thresholds), and may manage generation and transmission of any relevant requests to remote systems (e.g., to the server 125 of FIGS. 1-2.

The generation component 724C and/or the generation circuit 728 (which may correspond to the generation component 120 of FIG. 1) may be used to generate outputs or responses based on input sub-prompts or prompts, as discussed above. For example, the generation component 724C and/or the generation circuit 728 may process the prompt or sub-prompt using one or more machine learning models (e.g., LLMs) to generate output.

Though depicted as separate components and circuits for clarity in FIG. 7, the decomposition circuit 726, the request circuit 727, and the generation circuit 728 may collectively or individually be implemented in other processing devices of the processing system 700, such as within the CPU 702, the GPU 704, the DSP 706, the NPU 708, and the like.

Generally, the processing system 700 and/or components thereof may be configured to perform the methods described herein.

Notably, in other aspects, aspects of the processing system 700 may be omitted, such as where the processing system 700 is a server computer or the like. For example, the multimedia component 710, the wireless connectivity component 712, the sensor processing units 716, the ISPs 718, and/or the navigation processor 720 may be omitted in other aspects. Further, aspects of the processing system 700 maybe distributed between multiple devices.

### Example Clauses

Implementation examples are described in the following numbered clauses:

Clause 1: A method, comprising: receiving an input prompt for machine learning; decomposing the input prompt to generate a set of sub-prompts; generating a sequence of requests for sub-prompts of the set of sub-prompts that have sequential dependency; generating a parallel request for sub-prompts of the set of sub-prompts that do not have sequential dependency; based on evaluating the sequence of requests and the parallel request, generating an execution plan for using one or more machine learning models to generate a response to the input prompt; and outputting the response to the input prompt according to the execution plan.

Clause 2: A method according to Clause 1, wherein generating the execution plan comprises determining to offload the input prompt to one or more cloud-based machine learning models.

Clause 3: A method according to Clause 2, wherein determining to offload the input prompt comprises determining that a number of the set of sub-prompts satisfies a threshold value.

Clause 4: A method according to any of Clauses 2-3, wherein determining to offload the input prompt comprises determining that a number of cloud-based data retrievals for the set of sub-prompts satisfies a threshold value.

Clause 5: A method according to any of Clauses 2-4, wherein determining to offload the input prompt comprises: estimating a time to generate the response to the input prompt based on the sequence of requests and the parallel request; and determining that the time satisfies a threshold value.

Clause 6: A method according to any of Clauses 1-5, wherein generating the execution plan comprises: estimating a time to generate the response to the input prompt based on the sequence of requests and the parallel request; determining that the time fails to satisfy a threshold value; and locally generating the response to the input prompt according to the execution plan.

Clause 7: A method according to any of Clauses 1-6, further comprising generating the response, comprising: transmitting a first request of the sequence of requests to retrieve data for a first sub-prompt of the set of sub-prompts; receiving a first sub-response for the first request; and transmitting a second request of the sequence of requests based on the first sub-response.

Clause 8: A method according to any of Clauses 1-7, further comprising generating the response, comprising: transmitting the parallel request to retrieve data for a plurality of sub-prompts of the set of sub-prompts; receiving a sub-response for the parallel request; and generating the response based on the sub-response.

Clause 9: A method according to any of Clauses 1-8, further comprising generating the response, comprising: identifying a named entity in a first sub-prompt of the set of sub-prompts; and transmitting a request for data retrieval comprising the named entity and a request for a knowledge graph related to the named entity.

Clause 10: A method according to Clause 9, further comprising requesting a portion of the knowledge graph based on a set of related named entities based on the named entity.

Clause 11: A method according to any of Clauses 9-10, further comprising: receiving another input prompt for machine learning; and generating another response to the other input prompt using the knowledge graph.

Clause 12: A processing system comprising: a memory comprising processor-executable instructions; and one or more processors coupled to the memory and configured to execute the processor-executable instructions and cause the processing system to perform a method in accordance with any of Clauses 1-11.

Clause 13: A processing system comprising means for performing a method in accordance with any of Clauses 1-11.

Clause 14: A non-transitory computer-readable medium comprising computer-executable instructions that, when executed by one or more processors of a processing system, cause the processing system to perform a method in accordance with any of Clauses 1-11.

Clause 15: A computer program product embodied on a computer-readable storage medium comprising code for performing a method in accordance with any of Clauses 1-11.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors configured to execute the processor-executable instructions and cause the processing system to:
receive an input prompt for machine learning;
decompose the input prompt to generate a set of sub-prompts;
generate a sequence of requests for sub-prompts of the set of sub-prompts that have sequential dependency;
generate a parallel request for sub-prompts of the set of sub-prompts that do not have sequential dependency;
based on evaluating the sequence of requests and the parallel request, generate an execution plan for using one or more machine learning models to generate a response to the input prompt; and
output the response to the input prompt according to the execution plan.

2. The processing system of claim 1, wherein, to generate the execution plan, the one or more processors are configured to execute the processor-executable instructions and cause the processing system to determine to offload the input prompt to one or more cloud-based machine learning models.

3. The processing system of claim 2, wherein, to determine to offload the input prompt, the one or more processors are configured to execute the processor-executable instructions and cause the processing system to determine that a number of the set of sub-prompts satisfies a threshold value.

4. The processing system of claim 2, wherein, to determine to offload the input prompt, the one or more processors are configured to execute the processor-executable instructions and cause the processing system to determine that a number of cloud-based data retrievals for the set of sub-prompts satisfies a threshold value.

5. The processing system of claim 2, wherein, to determine to offload the input prompt, the one or more processors are configured to execute the processor-executable instructions and cause the processing system to:
estimate a time to generate the response to the input prompt based on the sequence of requests and the parallel request; and
determine that the time satisfies a threshold value.

6. The processing system of claim 1, wherein, to generate the execution plan, the one or more processors are configured to execute the processor-executable instructions and cause the processing system to:
estimate a time to generate the response to the input prompt based on the sequence of requests and the parallel request;
determine that the time fails to satisfy a threshold value; and
locally generate the response to the input prompt according to the execution plan.

7. The processing system of claim 1, wherein the one or more processors are configured to execute the processor-executable instructions and cause the processing system to generate the response and wherein, to generate the response, the one or more processors are configured to execute the processor-executable instructions and cause the processing system to:
transmit a first request of the sequence of requests to retrieve data for a first sub-prompt of the set of sub-prompts;
receive a first sub-response for the first request; and
transmit a second request of the sequence of requests based on the first sub-response.

8. The processing system of claim 1, wherein the one or more processors are configured to execute the processor-executable instructions and cause the processing system to generate the response and wherein, to generate the response, the one or more processors are configured to execute the processor-executable instructions and cause the processing system to:
transmit the parallel request to retrieve data for a plurality of sub-prompts of the set of sub-prompts;
receive a sub-response for the parallel request; and
generate the response based on the sub-response.

9. The processing system of claim 1, wherein the one or more processors are configured to execute the processor-executable instructions and cause the processing system to generate the response and wherein, to generate the response, the one or more processors are configured to execute the processor-executable instructions and cause the processing system to:
identify a named entity in a first sub-prompt of the set of sub-prompts; and
transmit a request for data retrieval comprising the named entity and a request for a knowledge graph related to the named entity.

10. The processing system of claim 9, wherein the one or more processors are configured to execute the processor-executable instructions and cause the processing system to request a portion of the knowledge graph based on a set of related named entities based on the named entity.

11. The processing system of claim 9, wherein the one or more processors are configured to execute the processor-executable instructions and further cause the processing system to:
receive another input prompt for machine learning; and
generate another response to the other input prompt using the knowledge graph.

12. A processor-implemented method of generative artificial intelligence (AI), comprising:
receiving an input prompt for machine learning;
decomposing the input prompt to generate a set of sub-prompts;
generating a sequence of requests for sub-prompts of the set of sub-prompts that have sequential dependency;
generating a parallel request for sub-prompts of the set of sub-prompts that do not have sequential dependency;
based on evaluating the sequence of requests and the parallel request, generating an execution plan for using one or more machine learning models to generate a response to the input prompt; and
outputting the response to the input prompt according to the execution plan.

13. The processor-implemented method of claim 12, wherein generating the execution plan comprises determining to offload the input prompt to one or more cloud-based machine learning models based on at least one of:
determining that a number of the set of sub-prompts satisfies a threshold value, or
determining that a number of cloud-based data retrievals for the set of sub-prompts satisfies a threshold value.

14. The processor-implemented method of claim 12, wherein generating the execution plan comprises determining to offload the input prompt to one or more cloud-based machine learning models based on:
estimating a time to generate the response to the input prompt based on the sequence of requests and the parallel request; and
determining that the time satisfies a threshold value.

15. The processor-implemented method of claim 12, wherein generating the execution plan comprises:
estimating a time to generate the response to the input prompt based on the sequence of requests and the parallel request;
determining that the time fails to satisfy a threshold value; and
locally generating the response to the input prompt according to the execution plan.

16. The processor-implemented method of claim 12, further comprising generating the response, comprising:
transmitting a first request of the sequence of requests to retrieve data for a first sub-prompt of the set of sub-prompts;
receiving a first sub-response for the first request; and
transmitting a second request of the sequence of requests based on the first sub-response.

17. The processor-implemented method of claim 12, further comprising generating the response, comprising:
transmitting the parallel request to retrieve data for a plurality of sub-prompts of the set of sub-prompts;
receiving a sub-response for the parallel request; and
generating the response based on the sub-response.

18. The processor-implemented method of claim 12, further comprising generating the response, comprising:
identifying a named entity in a first sub-prompt of the set of sub-prompts; and
transmitting a request for data retrieval comprising the named entity and a request for a knowledge graph related to the named entity.

19. The processor-implemented method of claim 18, further comprising requesting a portion of the knowledge graph based on a set of related named entities based on the named entity.

20. A processing system comprising:
means for receiving an input prompt for machine learning;
means for decomposing the input prompt to generate a set of sub-prompts;
means for generating a sequence of requests for sub-prompts of the set of sub-prompts that have sequential dependency;
means for generating a parallel request for sub-prompts of the set of sub-prompts that do not have sequential dependency;
means for generating, based on evaluating the sequence of requests and the parallel request, an execution plan for using one or more machine learning models to generate a response to the input prompt; and
means for outputting the response to the input prompt according to the execution plan.
